(19) United States
(12) Patent Application Publication
(10) Pub. No.: US 2009/0089882 A1
(43) Pub. Date: Apr. 2, 2009

(54) Methods and Apparatus for Restricting End-User Access to Content

(76) Inventors: Markus A. Hofmann, Fair Haven, NJ (US); Ivica Rimac, Tinton Falls, NJ (US)

Correspondence Address: Ryan, Mason & Lewis, LLP, Suite 205, 1300 Post Road, Fairfield, CT, 06824, US

(21) Appl. No.: 11/863,892

(22) Filed: Sep. 28, 2007

(51) Int. Cl. G06F 21/22

(52) U.S. Cl. 726/28

(57) ABSTRACT

Methods and apparatus are provided for restricting end-user access to content Access of an end-user to content is restricted by receiving a request from the end-user to access the content; identifying and authorizing user associated with the end-user; providing an authorization message to the authorizing user, wherein the authorizing user is remote from a location of the end-user; and providing the end-user with access to the content if authorized by the authorizing user. For example, the end-user can be a child and the authorizing user can be an individual responsible for the child, such as a parent or guardian. In a further variation, the end-user can be an automated recording device and authorization request is responsive to an attempt by the recording device to record the content.

### FIELD OF THE INVENTION

The present invention relates generally to content access control techniques, and more particularly, to methods and apparatus for authorizing access to restricted content by a remote user.

### BACKGROUND OF THE INVENTION

In order to prevent children and other unauthorized users from watching inappropriate content and to control the costs for pay-per-view content, many television and video systems incorporate access control features Users of many video satellite and cable services, for example, are often required to use a set-top box (STB) that typically provides an access control feature. The access control function is typically implemented as software executed by the STB that has to be locally enabled by an administrative user. Once enabled, the STB will automatically request an appropriate authorization code to access any access controlled channels or programs During operation, when attempting to access a program that is access controlled, the content stream is typically received at the STB but it is not to be the user until the user provides an appropriate authorization code

While existing STB-based program access control systems provide an effective mechanism for limiting access to programs, they suffer from a number of limitations, which it overcome, could further improve the utility and reliability of such content access control systems. For example, such systems typically depend on proper enabling and configuration by the end user to maintain consistent access control rights In addition, local presence in the home is typically required to adjust the filtering rules implemented by the access control system or to provide an appropriate authorization code. Thus, existing content access control mechanisms tightly couple the authorization process to the end point that is requesting the content. For successful authorization, the privileged user must be physically available or the authorization information must be disclosed to the requesting user.

A number of techniques have been proposed or suggested for server-side access control systems. A number of Internet Service Providers, for example, such as America Online, offer network-based user profiles and filters that can restrict access to content on the World Wide Web. With the America Online service, for example, parents can create screen names for their children and configure the parental control features to limit access to certain content categories. See, for example, http://www.aol.com/info/parentalcontrol.html

A need therefore exits for improved techniques for remote content access control for video and other content. A further need exists for improved server-based techniques for content access control.

### SUMMARY OF THE INVENTION

Generally, methods and apparatus are provided for restricting end-user access to content. According to one aspect of the invention, access of and end-user to content is restricted by receiving a request from the end-user to access the content; identifying and authorizing user associated with the end-user; providing and authorization message to the authorizing user, wherein the authorizing user is remote from a locating of the end-user; and providing the end-user with access to the content if authorized by the authorizing user For example, the end-user can be a child and the authorizing user can be an individual responsible for the child, such as a parent or guardian. In a further variation, the end-user can be an automated recording device and authorization request is responsive to an attempt by the recording device to record the content.

According to a further aspect of the invention, the method can be performed by a centralized server or a processor that is local to the end-user. In various embodiments, the authorization message can include options for the authorizing user to automatically obtain additional information about the requested content, established a communication channel between the authorizing user and the end-user; and authorize the end-user to access the restricted content. The authorization message can be provided to the authorizing user on one or more devices where the authorizing user is present.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment in which the present invention can operate;

FIG. 2 is a flow diagram illustrating the access control service center of FIG. 2 in further detail and the interaction of the access control service center with other entities in accordance with the present invention;

FIG. 3A is a sample table from the exemplary user profile of FIG. 2;

FIG. 3B is a sample table from the exemplary user database of FIG. 2;

FIG. 4 illustrates an exemplary session registration process for an end-user by a set-top box;

FIG. 5 is a screen shot of an exemplary EPG that may be presented to end the end-user following the registration process shown in FIG. 4;

FIG. 6 illustrates an exemplary forwarding of an authorization request by an end-user to an associated authorizing user in accordance with the present invention;

FIG. 7 is screen shot of an exemplary authorization request dialog box that is presented to the end-user whenever restricted content is selected;

FIG. 8 illustrates the processing of an authorization message by a remote authorizing user in accordance with one embodiment of the present invention;

FIG. 9 illustrates the establishment of a communication link between the remote authorizing user and the end-user as part of the authorization request; and

FIG. 10 illustrates the approval of an authorization request by a remote authorizing user in accordance with the present invention.

### DETAILED DESCRIPTION

The present invention provides a methods and apparatus for restricting access of an end-user to content. According to one aspect of the present invention, when an unauthorized user, such as a child, requests to access restricted content, the service intervenes and identifies an authorizing user associated with the end-user. In the case of a child, for example, the authorizing user may be an individual responsible for the child, such as a parent, guardian or teacher of the child. The disclosed service then provides an authorization message to the authorizing message to the authorizing user to determine if the unauthorized user can access the restricted content. According to a further aspect of the present invention, the authorizing user is remote from a location of the unauthorized user. The unauthorized user is provided with the access to the content only if authorized by the authorizing user.

According to a further aspect of the present invention, the authorizing user receives the authorization message by one or more of email, instant message, text message, or a telephone call. The authorizing user can decide whether to authorize the request. In addition, the authorizing user can optionally be provided with additional information, such as reviews or a portion of the requested content, to help determine whether the requested content is appropriate for the unauthorized user. For example, the authorization message that is sent to the authorizing user can include a link to the additional information, such as information from the electronic program guide (EPG) and a video trailer. Furthermore, the authorization request also includes addresses the content-requesting user is registered with, which allows easy setup of a direct communication channel.

In one exemplary embodiment, the filtering rules for the content, such as the parental control settings, are centrally hosted in the provider network and linked with the user profile.

In this manner, one embodiment of the present invention controls access to content, such as IP-based video services, through a network-instance rather than locally on the receiving end devices, in order to increase the flexibility and convenience of content access control. The present invention allows authorization requests for content to be forwarded to, and remotely processed on, other end points, such as a cellular telephone or another portable device. Furthermore, instant invocation of other services is enabled by exchange of content information. That is, various aspects of the invention provide convenient access to additional information associated with the requested video content and instant placement of a communication channel to the authorizing user

In an exemplary parental control example, when a child tried to access a TV program, the proposed system allows the authorization request issued by the network-hosted instance to be forwarded to an authorizing user for the child, such as a parent, simply using buttons on the remote control. Once the authorizing user receives the forwarded authorization request e.g., in a cellular telephone, the authorizing user can remotely grant or deny access to the requested TV program on the cellular telephone To help with the decision, the authorizing user optionally receives the authorization request enriched with a link to metadata for the requested program. Furthermore, the authorizing user might forward the request to another individual, such as another parent, or place a telephone call to the child, for example, by a single keystroke.

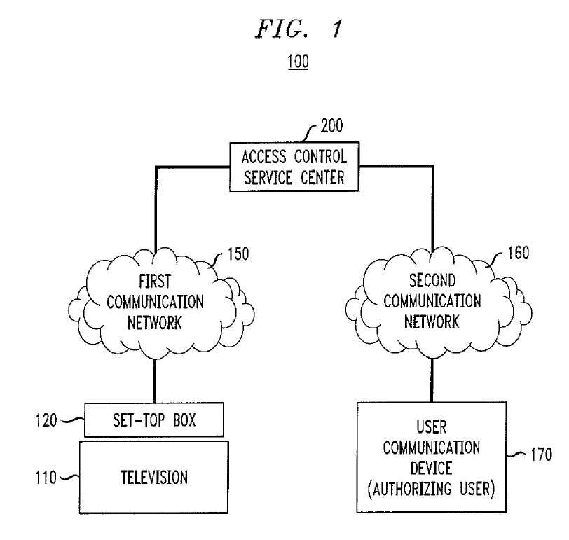

FIG. 1 illustrates an exemplary network environment 100 in which the present invention can operate. As shown in FIG. 1, the present invention provides an access control service center 200, discussed further below in conjunction with FIG. 2, for restricting access to content in accordance with the present invention. The exemplary network environment 100 comprises a first communication network 150 for communications between the access control service center 200 and the local end-user environment comprising, for an example, a television 110 and the set-top box 120. The first communications network 150 may be embodied, for example, as the network of the content service provider, such as a cable or satellite network. The exemplary network environment 100 also comprises a second communication network 160 for communications between the access control service center 200 and one or more communication devices 170 associated with the remote authorizing user. The second communication network 160 may be embodied, for example, as any available wired or wireless communication network (or a combination thereof), including the Internet, cellular telephone network or the Public Switched Telephone Network (PSTN).

It is noted that while the present invention is illustrated in the context of exemplary video content, the present invention can be applied to restrict access to any content, including audio or Internet content, as would be apparent to a person of ordinary skill in the art. In addition, while the present invention is illustrated in the context of a network environment 100 having two exemplary sub-remarks 150, 160 it is recognized that the two exemplary sub-networks 150, 160 could ultimately be merged into a single network.

FIG. 2 is a flow diagram illustrating the access control service center 200 of FIG. 2 in further detail and the interaction of the access control service center 200 with other entities in accordance with the present invention. In the exemplary embodiment of FIG. 2, the access control service center 200 is compromised of middleware 202 and a remote controller 205 In addition, the middleware 202 includes an interface to the 205. FIG. 2 also includes a dotted line 210 representing the separation of functions of the present invention between the domain of the first communication network 150 and the domain of the second communication network 160.

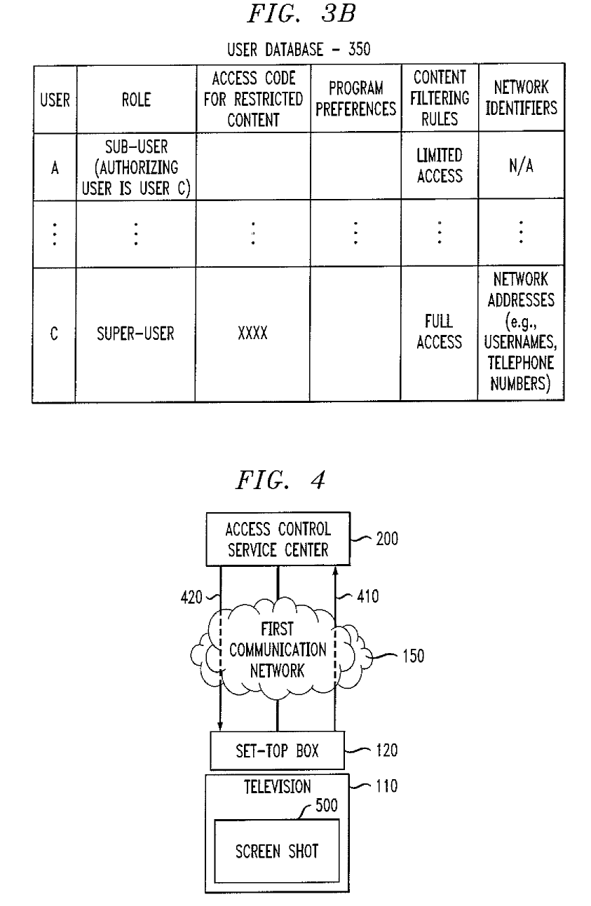

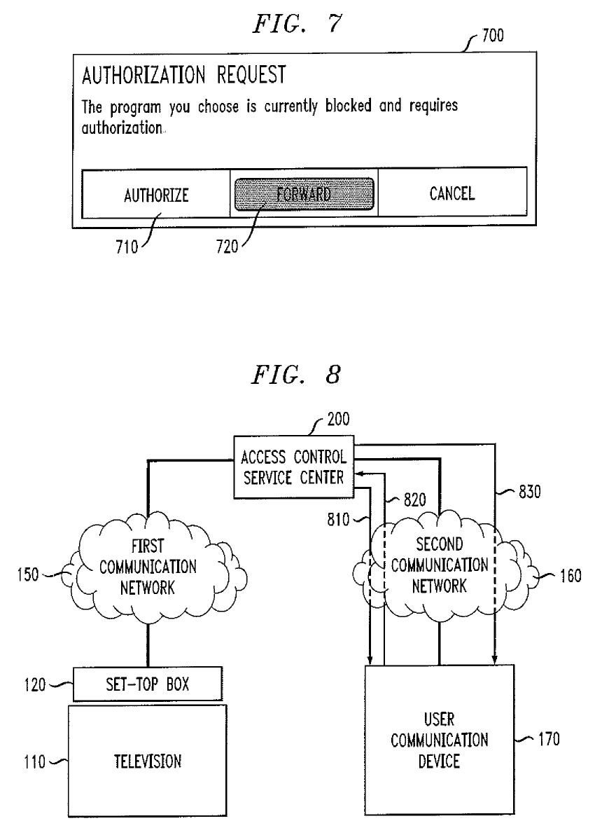

From a process point of view, the present invention is initiated upon receipt of a request 220 from the end-user set-top box 120 for restricted content. Generally, restricted content comprises, for example, a program that is currently blocked according to the user's profile. As discussed further below in conjunction with FIGS. 4 and 6, the middleware 202 issues an authorization request to the set-top box 120 of the content requesting originating end point when the end-user is prompted (for example, on the screen of the television 110) for authorization data, the user can reply with an authorization-forwarding request (simply using the STB's remote control), as discussed further below in conjunction with FIG. 7, to have an authorization message automatically forwarded to the authorizing user.

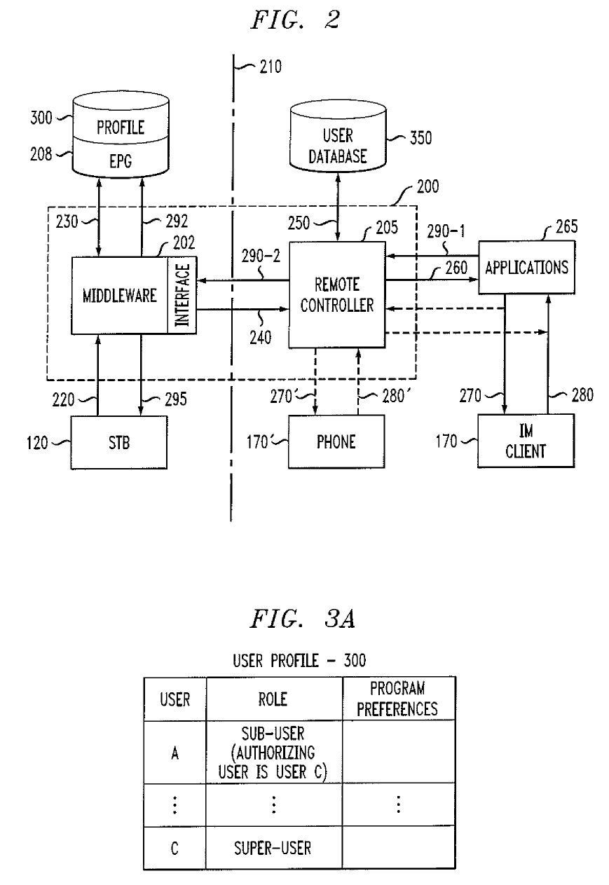

As discussed further below in conjunction with FIG. 6, the authorization-forwarding request triggers an authorization message being sent to the authorizing user over one or more available communication channels that the authorizing user implicitly provided through the user profile information or that was explicitly provided by the requesting user. If needed, the middleware 202 accesses the user's profile 208, discussed further below in conjunction with FIG. 3A, during step 230 to identify the authorizing user associated with this end-user. Optionally, the authorization-forwarding request might be triggered automatically, when the user switches and stays on a blocked program for a certain period of time. It is noted that the usage of timer events might reduce unnecessary signaling during a fast channel change.

In the exemplary embodiment of FIG. 2, the middleware 202 sends the authorization message to the remote controller 205 during step 240. The authorization message provides the necessary information to the remote controller 205, such as an indication of the end-user, authorizing user, and a global program identifier.

As previously indicated, the authorization message can be provided to the authorizing user on at least one of a plurality of devices associated with the authorizing user. During step 250 the remote controller 205 can access a user database 350, discussed further below in conjunction with FIG. 3B, to identify the devices associated with the authorizing user. As discussed further below, the user database 350 optionally indicates the presence status of the authorizing user on each identified device.

In the exemplary embodiment, it is assumed that the remote controller 205 accesses certain devices directly, such as a telephone 170′, and accesses additional devices 170, such as IM devices, indirectly, by means of one or more applications 265. Thus, during step 270 or 270′, the authorization message is sent to one or more communications devices 170, 170′associated with the authorizing user In one embodiment, the authorization message is only sent to devices 170, 170′ where the authorizing user is believed to be present. The communication channel with the authorizing user can comprise an appropriate dialog format to exchange reply options and choice parameters for example, messages, can be exchanged in a request-reply dialog using a machine-readable format (e.g., SMS, IM, and Email). However, if an authorizing user is available only over a standard telephone, voice dialogs and touch-tone service can be implemented to support plain telephony.

As discussed further below in conjunction with FIG. 8, the authorizing user responds to the authorization message during step 280 Finally, during step 290, response from the authorizing user to the authorization message is processed by the remote controller 205, which signals the result to the middleware 202. As discussed further below in conjunction with FIG. 10, the middleware 202 updates the access control status of the requested content in an EPG 208 during step 292 and updates the STB 120 during step 295.

FIG. 3A is a sample table from the exemplary user profile 300 of FIG. 2. As shown in FIG. 3A, the exemplary user profile 300 contains a record for each end-user. For each end-user, the exemplary user profile 300 indicates a content access role for each user, such as whether the user is a sub-user with limited access or a super-user with full access, as well as program preferences. If a user is identified as a sub-user, the exemplary user profile 300 preferably identifies the authorizing user(s) associated with the sub-user. In addition, the content filtering rules optionally contains one or more rules that limit the ability of a sub-user to access content. The program preferences may be used, for example, by a digital video recording (DVR) feature of a set-top box 120.

FIG. 3B is a sample table from the exemplary user database 350 of FIG. 2. As shown in FIG. 3B, the exemplary user database 350 contains a record for each end-user. For each end-user, the user database 350 indicates a content access role for each user, such as whether the user is a sub-user with limited access or a sub-user with full access, an access code that is required to authorize access to restricted content, program preferences, content filtering rules, and one or more network identifiers for each sub-user that may be used to contact the authorizing user. For example, the network identifiers can include one or more usernames, SIP addresses, VoIP account names, email addresses, telephone numbers or other logical addresses/identifiers. In addition, the user database 350 optionally indicates the presence status of the authorizing user on each identified device. Alternatively, presence information can be obtained in real-time from a presence server (not shown).

It is noted that in various embodiments, the user profile 300 of FIG. 3A and the user database 350 of FIG. 3B can be integrated into a single data store maintained centrally by the access control service center 200 or locally by the corresponding set-top box 120, as would be apparent to a person of ordinary skill in the art. In addition, the user profile 300 of FIG. 3A could be configured to contain additional fields, such as being a copy of the user database 350 of FIG. 3B.

FIGS. 4, 6 and 8-10 illustrate various sequential aspects of an exemplary forwarding of a request for restricted content from an unauthorized end-user, such as a child, to a remote authorizing user, in accordance with the present invention. FIG. 4 illustrates an exemplary session registration process for an end-user by a set-top box 120 As shown in FIG. 4, the set-top box 120 initially sends registration information to the access control service center 200 during step 410, for example, after the end-user turns on the television 110 and set-top box 120. During step 420, the access control service center 200 forwards the user profile 300, applies the content filtering rules from the user database 350 and sends the updated EPG 208 to the set-top box 120.

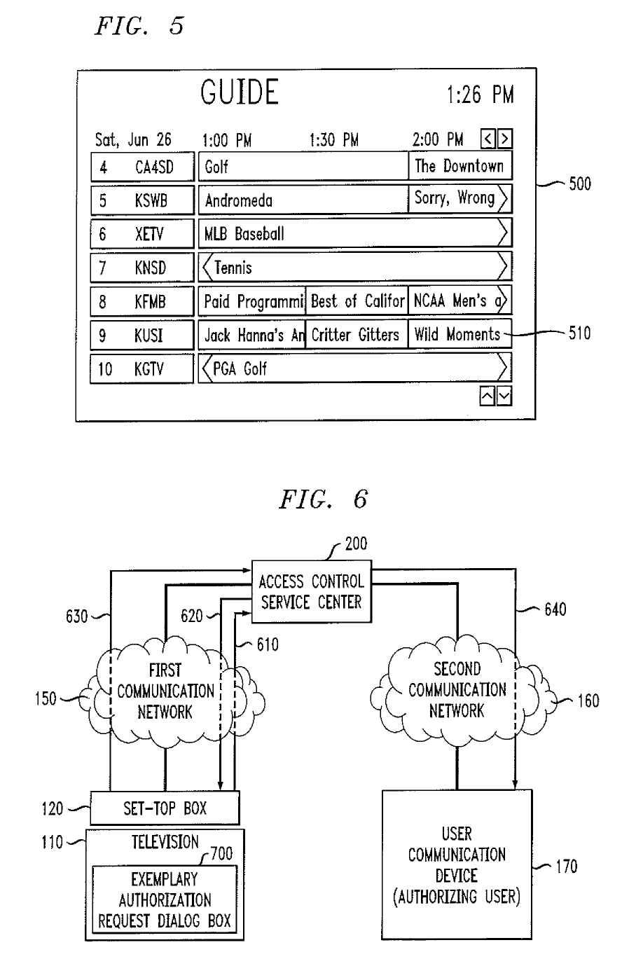

FIG. 5 is a screen shot 500 of an exemplary EPG 208 that may be presented to the end-user following the registration process shown in FIG. 4. In the example of FIG. 5, assume that the content “Wild Moments” illustrated in cell 510 of FIG. 5 corresponds to restricted content that is selected by the end-user. It is noted that in the exemplary embodiment discussed herein, the content filtering rules are applied by the access control service center 200 during step 420 before the EPG 208 is provided to the set-top box 120. Thus, it a user selects restricted content from the EPG 208, an authorization request is automatically triggered as discussed hereinafter.

FIG. 6 illustrates an exemplary forwarding of an authorization request by an end-user to an associated authorizing user in accordance with the present invention FIG. 6 assumes that the registration process of FIG. 4 has been completed. Assume further that the content filtering rules form the end-user (a sub-user), specify a standard policy of “newscast only.” As shown in FIG. 6, during step 610, the end-user requests restricted content, such as the program “Wild Moments” 510 from the EPG shown in FIG. 5. Since the requested program is restricted content based on the content filtering rules for this end-user; the access control service center 200 will deny access and prompt the end-user during step 620 for an authorization code. As discussed further below in conjunction with FIG. 7, the end-user requests during step 630 that the authorization request be forwarded to an authorizing user. The end-user can either specify a particular authorizing user, for example, by telephone number or email address, or the authorizing user previously specified for the end-user can be obtained from the user database 350. During step 640, the access control service center 200 accesses the user database 350 to obtain the forwarding contact of the authorizing user, determines the presence status of the indicated authorizing user, and forwards the authorization request to one or more identified communication devices 170 of the authorizing user.

FIG. 7 is a screen shot of an exemplary authorization request dialog box 700 that is presented to the end-user whenever restricted content is selected. The exemplary authorization request dialog box 700 includes a button 710 to allow the end-user to directly enter an authorization code and a button 720 to forward the authorization request to an authorizing user. If the end-user clicks on button 710, the authorization request is processed in a conventional manner. If the end-user clicks on button 720, the authorization request is processed in accordance with the present invention.

FIG. 8 illustrates the processing of an authorization message by a remote authorizing user in accordance with one embodiment of the present invention as shown in FIG. 8, the authorization request is forwarded to one or more identified communication devices 170 of the authorizing user during step 810. For example, the authorizing user may receive the authorization message on his or her cell phone. The authorization message may optionally includes options, such as links, to retrieve metadata about the restricted content, including a video trailer; or to establish a communication with the requesting end-user. In addition, the exemplary authorization message includes an option that allows the authorizing user to easily reject or accept the authorization, for example, with a single keystroke. If the authorizing user elects to see a portion of the restricted content during step 820, the access control service center 200 will provide the requested portion to the device 170 of the authorizing user during step 830.

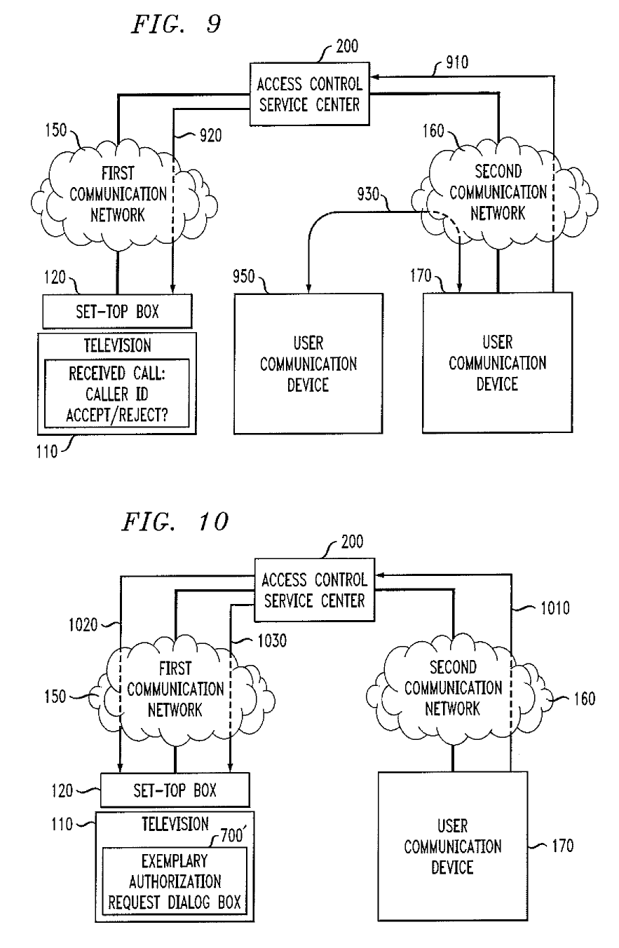

FIG. 9 illustrates the establishment of a communication link between the remote authorizing user and the end-user as part of the authorization request. For example, a parent may wish to speak to the requesting child to determine if they have completed their homework or chores, before authorizing the restricted content. Step 830 illustrated the access control service center 200 providing the requested portion to the device 170 of the authorizing user. Thereafter, during step 910, the authorizing user can initiate a call to the requesting end-user, for example, by clicking on a link in the authorization message. During step 920, a communication device 950 of the requesting user, such as a telephone will ring, and a caller ID can optionally be displayed on the screen of the television 110. If the requesting user picks up the telephone 950, a communication link 930 is established between the communication device 950 of the requesting user and the communication device 170 of the authorizing user. In this manner, the authorizing user can communicate directly with the requesting user to further assess whether the authorization request should be granted.

FIG. 10 illustrates the approval of an authorization request by a remote authorizing user in accordance with the present invention. Upon approval, the requesting user can be notified, for example, by a notification on the screen of the television 110 that the requested program is now available. As shown in FIG. 10, the authorizing user decides during step 1010 to authorize the requesting user to watch the requested program. This can be achieved, for example, by clicking on an “accept” button in the authorization message. The access control service center 200 then processes the approval during step 1020 by updating the EPG 208 for the requesting end user and transmitting a notification to the set-top box 120. Upon receiving the notification, the requesting end-user switches back to the requested program and starts receiving the corresponding stream during step 1030.

While the figures herein show an exemplary sequence of steps, it is also an embodiment of the present invention that the sequence may be varied. Various permutations of the algorithm are contemplated as alternate embodiments of the invention. In addition, while exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware Such software may be employed in, for example, a digital signal processor, micro-controller, or general-purpose computer Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention when implemented on a general-purpose processor, the program code segments combine with the processor to provide a device that operates analogously to specific logic circuits. The invention can also be implemented in one or more of an integrated circuits, a digital signal processor, a microprocessor, and a micro-controller.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel) Any medium known or developed that can store information suitable for use with a computer system may be used. The computer-readable code means is any mechanism for allowing a computer to read instructions and data, such as magnetic variations on a magnetic media or height variations on the surface of a compact disk

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for restricting access of an end-user to content, comprising:
receiving a request from said end-user to access said content;
identifying an authorizing user associated with said end-user;
providing an authorization message to said authorizing user, wherein said authorizing user is remote from a location of said end-user; and
providing said end-user with access to said content if authorized by said authorizing user.

2. The method of claim 1, wherein said end-user is a child and said authorizing user is an individual responsible for said child.

3. The method of claim 1, wherein said end-user is an automated recording device and wherein said receiving step is responsive to an attempt by said recording device to record said content.

4. The method of claim 1, wherein said content is a pay-per-view content item.

5. The method of claim 1, wherein said method is performed by a centralized server.

6. The method of claim 1, wherein said method is performed by a processor that is local to said end-user.

7. The method of claim 1, further comprising the step of establishing a communication channel between said authorizing user and said end-user.

8. The method of claim 1, wherein said authorization message is provided to said authorizing user on a device where said authorizing user is present.

9. The method of claim 1, wherein said authorization message includes a mechanism to allow said authorizing user to automatically authorize said authorization request.

10. The method of claim 1, further comprising the step of providing said authorizing user with information about said content.

11. The method of claim 1, wherein said authorization message is provided to said authorizing user on at least one of a plurality of devices associated with said authorizing user.

12. A system for restricting access of an end-user to content, comprising:
a memory; and
at least one processor, coupled to the memory, operative to:
receive a request from said end-user to access said content;
identify an authorizing user associated with said end-user;
provide an authorization message to said authorizing user, wherein said authorizing user is remote from a location of said end-user; and
provide said end-user with access to said content if authorized by said authorizing user.

13. The system of claim 12, wherein said end-user is a child and said authorizing user is an individual responsible for said child.

14. The system of claim 12, wherein said end-user is an automated recording device and wherein said receiving step is responsive to an attempt by said recording device to record said content.

15. The system of claim 12, wherein said processor is further configured to establish a communication channel between said authorizing user and said end-user.

16. The system of claim 12, wherein said authorization message is provided to said authorizing user on a device where said authorizing user is present.

17. The system of claim 12, wherein said authorization message includes a mechanism to allow said authorizing user to automatically authorize said authorization request.

18. The system of claim 12, wherein said processor is further configured to provide said authorizing user with information about said content.

19. The system of claim 12, wherein said authorization message is provided to said authorizing user on at least one of a plurality of devices associated with said authorizing user.

20. An article of manufacture for restricting access of an end-user to content, comprising a machine readable medium containing one or more programs which when executed implement the steps of:
receiving a request from said end-user to access said content;
identifying an authorizing user associated with said end-user;
providing an authorization message to said authorizing user, wherein said authorizing user is remote from a location of said end-user; and
providing said end-user with access to said content if authorized by said authorizing user.
